(19) United States
(12) Patent Application Publication
(10) Pub. No.: US 2020/0122302 A1
(43) Pub. Date: Apr. 23, 2020

(54) FIXATION SYSTEM, SUPPORT PLATE AND METHOD FOR PRODUCTION THEREOF

(71) Applicant: SUSS MicroTec Lithography GmbH, Garching (DE)

(72) Inventors: Philippe STIEVENARD, Garching (DE); Gerhard HECKL, Garching (DE)

(21) Appl. No.: 16/661,744

(22) Filed: Oct. 23, 2019

(30) Foreign Application Priority Data
Oct. 23, 2018 (NL) 2021859

(51) Int. Cl. B25B 11/00

(52) U.S. Cl. CPC B25B 11/005

(57) ABSTRACT

A fixation system for fixing a flexible substrate includes a handling device and a support plate being separate from the handling device. The handling device has a bearing surface with vacuum openings. The support plate has support surface for supporting the substrate and a connection surface in contact with the bearing surface of the handling device. The support plate has through holes extending from the support surface to the connection surface, wherein at least one of the through holes is fluidically connected to one of the vacuum openings of the handling device. Moreover, a support plate for a fixation system as well as a method for producing a support plate are disclosed.

### FIELD OF THE DISCLOSURE

The disclosure relates to a fixation system for fixing a flexible substrate, a support plate for a fixation system as well as to a method for producing a support plate.

### BACKGROUND

Semiconductor processing machines, such as mask aligners or end effectors, use vacuum holders, e.g. chucks, to apply a vacuum to substrates. In order to hold them for further processing. For example, mask aligners use vacuum holders to position the substrate (such as a wafer) and a mask for a subsequent exposure of the substrate.

The vacuum holders are usually designed for rigid substrates, i.e. substrates that do not substantially bend under the effect of gravity. Accordingly, the vacuum holders are usually smaller than the substrate to be held and/or only apply a vacuum in a center region of the substrate.

When processing flexible substrates such as foils or thin wafers, this can lead to bending of the substrate, considerable stress on the substrate material and/or imprints of surface structures of the vacuum holder onto the substrate.

### SUMMARY

There is a need to provide a fixation system that is capable of holding flexible substrates without the disadvantages mentioned above.

According to the disclosure, the problem is solved by a fixation system for fixing a flexible substrate, comprising a handling device and a support plate being separate from the handling device. The handling device comprises a bearing surface with vacuum openings. The support plate comprises a support surface for supporting the substrate and a connection surface in contact with the bearing surface of the handling device. The support plate comprises through holes extending from the support surface to the connection surface, wherein at least one of the through holes is fluidically connected to one of the vacuum openings of the handling device.

For fixing the flexible substrate, it is positioned on the support surface of the support plate and a vacuum is applied to the vacuum openings of the bearing surface. The vacuum is passed through the through holes of the support plate and applied to the substrate, which s thus safely fixated on the support surface.

Throughout the following, the expression “apply a vacuum” denotes that fluid is evacuated from the corresponding area. For example, applying a vacuum to the vacuum openings means that fluid, e.g. air or liquid, is evacuated from the area defined by the vacuum openings. This corresponds to establishing a pressure in the respective area that is lower than a reference pressure in the environment of the fixation system.

The separate support plate is configured to be rigid and therefore supports the flexible substrate, in particular over the entire area of the flexible substrate. Thus, bending of the substrate, stress on the substrate material and imprint effects are effectively reduced or even completely prevented while the flexible substrate is fixated for further processing.

The support plate is configured as an attachment to the handling device. For handling different kinds and sizes of substrates, the support plate may be simply replaced with another one adapted to the particular substrate and/or substrate size. Thus, it is possible to use the same handling device for a large variety of different substrates and substrate sizes.

Preferably, the area of the support plate is larger than the area of the substrate to be fixated, such that the support plate fully supports the flexible substrate over its entire area.

The support plate may be formed as a disk or may have an arbitrary form. In particular, the shape of the support plate may be adapted to match a particular form of a substrate to be fixated.

In a certain embodiment of the disclosure, the support plate comprises vacuum grooves in the support surface that are each fluidically connected to at least one through hole. Via the vacuum grooves, the vacuum is distributed to a larger area of the flexible substrate such that the vacuum is applied to the flexible substrate more uniformly. Thus, forces acting on the flexible substrate due to the applied vacuum are also distributed more uniformly. Consequently, stress on the substrate material and imprint effects related to an uneven pressure distribution are reduced or even completely prevented.

According to one aspect of the disclosure, the vacuum grooves extend radially outwards from a center point of the support plate, in an azimuthal direction of the support plate and/or along a contour similar to a contour of the substrate. The term “similar” denotes that at least one of the vacuum grooves may resemble at least parts of the contour of the flexible substrate. In particular, a contour defined by at least one of the vacuum grooves may be similar to the contour of the flexible substrate in a mathematical sense, more specifically equal or downscaled in size.

Preferably, at least one vacuum groove extends along a curve that is at least piecewise similar to an outer circumference of the flexible substrate, such that the substrate is safely fixated at its edge or edges.

According to another aspect of the disclosure, the support plate comprises an alignment structure, in particular the alignment structure comprising an engraving, a notch and/or an alignment mark. The alignment structure allows an exact positioning of the flexible substrate on the support surface and/or an exact positioning of the support plate on the handling device.

The handling device and/or the support plate may be translucent at least sectionally. In particular, the support plate may be translucent in areas that are allocated to windows comprised in the handling device. This enables a backside alignment of the flexible substrate and therefore a particularly accurate positioning of the flexible substrate on the support plate and/or of the support plate on the handling device.

In another embodiment of the disclosure, the support plate, at least partly, consists of a photostructurable glass. In particular, the vacuum grooves and/or the through holes are produced by exposing and subsequently etching the photostructurable glass. This kind of production process enables a particularly high accuracy of the grooves and through holes. Moreover, it enables a particularly high aspect ratio (depth of a structure divided by its width) of the produced vacuum grooves and through holes.

Alternatively, the support plate may consist of another type of glass or metal.

According to another aspect of the disclosure, the support plate comprises vacuum grooves in the connection surface that are each fluidically connected to at least one through hole, in particular wherein a width and/or a length of the vacuum grooves provided in the connection surface is bigger than a width and/or a length of vacuum grooves provided in the support surface. The vacuum grooves provided in the connection surface are positioned over the vacuum openings such that the through holes are fluidically connected to the vacuum openings via the vacuum grooves. Due to these vacuum grooves with bigger width and/or a length provided in the connection surface, positioning errors and/or size tolerances of the support surface are compensated, as the through holes do not have to be perfectly positioned over the vacuum openings.

The through holes and/or the vacuum grooves may have an aspect ratio bigger than 2.5, preferably bigger than 5, in particular bigger than 10. In other words, the vacuum grooves and/or the through holes are very narrow, which effectively prevents the flexible substrate from locally deforming into the recesses defined by the vacuum grooves and/or through holes.

According to a further aspect of the disclosure, at least two of the through holes are fluidically separate on the connection surface and/or on the support surface. In other words, the at least two through holes are not interconnected on the connection surface and/or on the support surface. Thus, for example, a vacuum of predefined strength may be applied to each of the at least two through holes, wherein the strength of the vacuum may vary between the at least two through holes such that a different predefined force may be applied to different regions of the flexible substrate.

In particular, all of the through holes are fluidically separate on the connection surface and/or on the support surface. Thus, for example, a vacuum of predefined strength may be applied to each of the through holes, wherein the strength of the vacuum may vary between the through holes such that a different predefined force may be applied to different regions of the flexible substrate.

According to another aspect of the disclosure, the support plate comprises at least ten through holes, in particular at least 20 through holes. The large number of through holes allows that the vacuum grooves individually cover a small surface so that bending or imprint effects are further reduced.

The support plate may comprise a receiving section on the support surface. The receiving section is configured to receive the flexible substrate. Thus, the receiving section may resemble the shape of the substrate. In particular, the receiving section has a smaller overall area than the support plate. Accordingly, the substrate is placed on a subarea of the support plate and is therefore entirely supported.

For example, the through holes are provided in the receiving section. Thus, the through holes are concentrated in a subarea of the support plate that is actually used for fixating the flexible substrate.

In particular, the handling device is a chuck and/or an end effector. For example, the support plate is configured as an attachment to the chuck and/or the end effector, respectively.

For handling different kinds of substrates and substrate sizes, the support plate may simply be replaced with another one adapted to the particular substrate and/or substrate size. Thus, it is possible to use the same chuck and/or the same end effector for a large variety of different substrates and substrate sizes.

According to the disclosure, the problem is also solved by a support plate for a fixation system for fixing flexible substrates, in particular for a fixation system as described above. The support plate comprises a support surface for supporting the substrate and a connection surface for connecting the support plate with a handling device, wherein the support plate comprises through holes extending from the support surface to the connection surface, wherein at least two of the through holes are fluidically separate on the connection surface. With respect to the effects and advantages, reference is made to the explanations given above.

According to the disclosure, the at least two through holes are fluidically separate on the connection surface. In other words, there is no connecting structure between the at least two through holes on the connection surface. In particular, all through holes may be fluidically separate on the connection surface. Each of the through holes can be connected with a corresponding port of a vacuum generating device. Thus, a vacuum of predefined strength may be applied to each of the through holes, in particular the strength of the vacuum may vary between the through holes such that a different predefined force may be applied to different regions of the support surface.

The support plate may comprise at least ten through holes, in particular at least 20 through holes. The large number of through holes allows that the through holes individually cover a small surface so that bending or imprint effects are further reduced.

According to the disclosure, the problem is also solved by a method for producing a support plate for a fixation system for fixing a flexible substrate, in particular as described above, comprising the following steps:
providing a base body made of a photostructurable glass;
arranging a photo mask on the base body;
exposing the base body; and
etching the base body creating vacuum grooves and/or through holes.

This kind of production process enables a particularly high accuracy of the grooves and through holes. Moreover, it enables a particularly high aspect ratio (depth of a structure divided by its width) of the produced vacuum grooves and through holes. For example, an aspect ratio of the vacuum grooves and/or of the through holes of more than 10 is achievable via the production process described above.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows a fixation system according to the disclosure;

FIG. 2 shows the fixation system of FIG. 1 with a flexible substrate attached;

FIG. 3 shows a support plate according to the disclosure;

FIG. 4 shows the support plate of FIG. 3 with a flexible substrate attached;

FIG. 5 shows a second embodiment of a fixation system according to the disclosure;

FIG. 6 shows the fixation system of FIG. 5 with a flexible substrate attached;

FIG. 7 shows a second embodiment of a support plate according to the disclosure;

FIG. 8 shows the support plate of FIG. 7 with a flexible substrate attached; and

FIG. 9 shows a schematic flow chart of a method for producing a support plate according to the disclosure.

### DETAILED DESCRIPTION

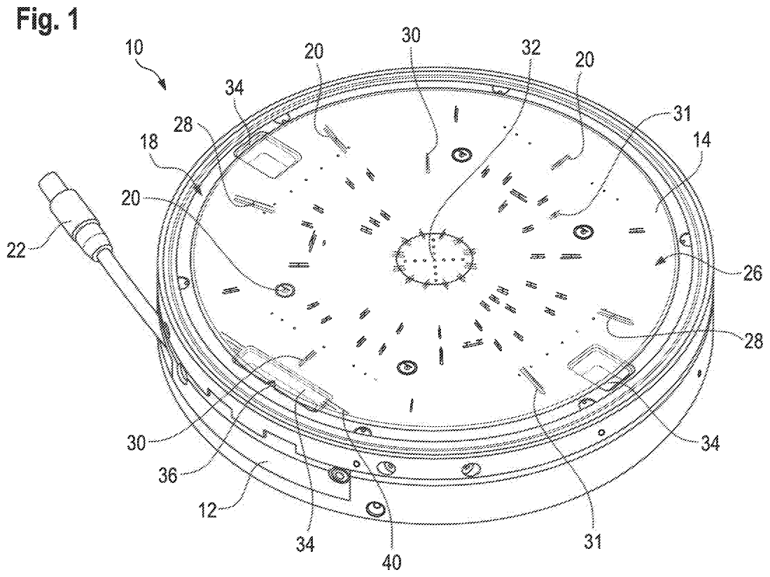

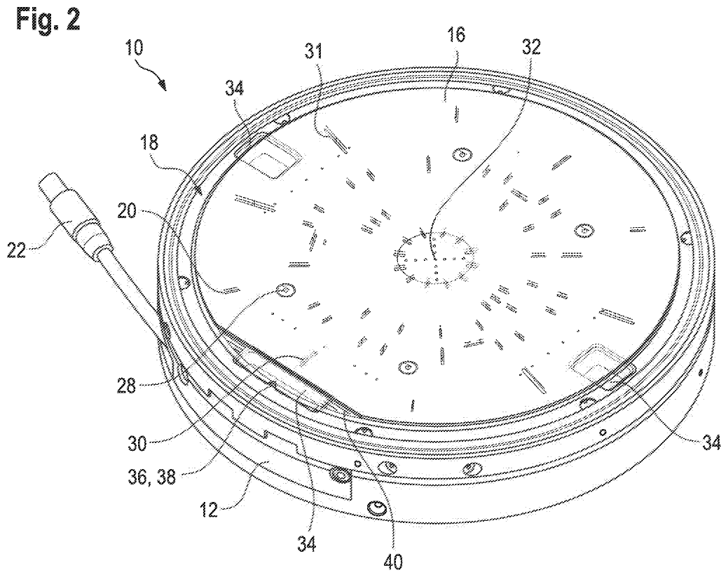

FIGS. 1 and 2 show a fixation system 10 comprising a handling device 12 and a support plate 14 being separate from the handling device 12. The fixation system 10 is configured to fixate a flexible substrate 16 (see FIG. 2).

For example, the fixation system 10 may be part of a semiconductor processing machine, like a mask aligner wherein the fixation system 10 fixates the flexible substrate 16 for further processing, e.g. for alignment relative to a photo mask and subsequent exposure.

In the example shown in FIGS. 1 and 2, the handling device 12 is configured as a mask aligner chuck. However, the handling device 12 may also be configured as another type of chuck and/or as an end effector. The explanations given below apply to all of these cases.

The handling device 12 comprises a bearing surface 18 with vacuum openings 20, to which a vacuum can be applied.

Throughout the following, the expression “apply a vacuum” denotes that fluid is evacuated from the corresponding area. For example, applying a vacuum to the vacuum openings 20 means that fluid, e.g. air or liquid, is evacuated from the area defined by the vacuum openings 20. This corresponds to establishing a pressure in the respective area that is lower than a reference pressure in the environment of the fixation system 10.

For applying the vacuum to the vacuum openings 20, the handling device 12 may comprise a vacuum port 22 via which the handling device 12 is connectable to a vacuum generating device. Alternatively or additionally, the handling device 12 may be configured to generate a vacuum and to apply the vacuum to the vacuum openings 20.

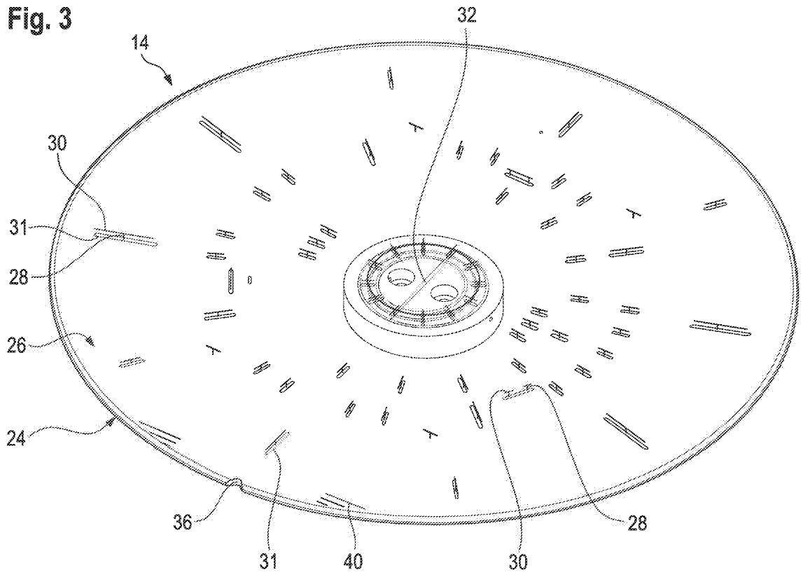

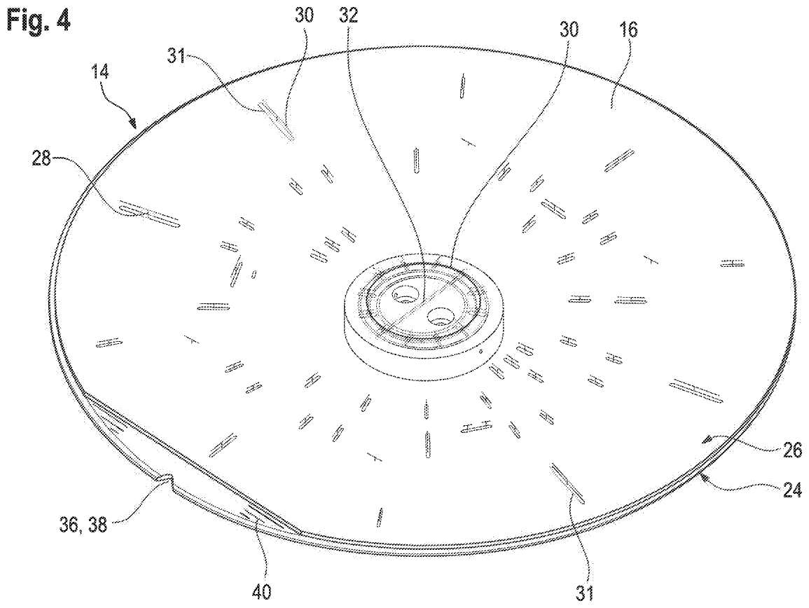

The support plate 14, which is also depicted in FIGS. 3 and 4, is shaped as a disk and comprises a connection surface 24 and a support surface 26. The support plate 14 may essentially be of the size of the flexible substrate 16 or bigger.

The support plate 14 comprises through holes 28 that extend from the connection surface 24 to the support surface 26. Preferably, at least 20 through holes 28 are provided.

Preferably, vacuum grooves 30 are provided on the support surface 26, such that the vacuum is more uniformly distributed over the area allocated to the flexible substrate 16.

Each of the vacuum grooves 30 is fluidically connected to at least one through hole 28, but may also be fluidically connected to several through holes 28.

In contrast, the through holes 28 are fluidically separate on the connection surface 24, i.e. not connected by grooves or the like in the connection surface 24, such that a vacuum of different lengths may be applied to the different through holes 28.

Moreover, vacuum grooves 31 may also be provided on the connection surface 24. Preferably, each of the vacuum grooves 31 is fluidically connected with exactly one of the through holes 28 such that each of the vacuum grooves 30 is connected to at least one of the vacuum grooves 31.

The vacuum grooves 31 provided in the connection surface 24 are positioned over the vacuum openings 20 such that the respective through holes 28 are fluidically connected to the vacuum openings 20 via the vacuum grooves 31.

A width and/or a length of the vacuum grooves 31 provided in the connection surface 24 may be bigger than a width and/or a length of the vacuum grooves 30 provided in the support surface 26. The width and/or the length of the vacuum grooves 31 may be at least 25% bigger than the width of the vacuum grooves 30, in particular at least 50% bigger, for example at least 100% bigger.

As can be seen in FIGS. 1 to 4, some of the vacuum grooves 30 extend essentially radially outwards from a center point 32 of the support plate 14, while other vacuum grooves 30 extend essentially in an azimuthal direction of the support plate 14.

The vacuum grooves 30 may be distributed symmetrically over the support surface 26. In the example shown. In FIGS. 1 to 4, the distribution of the vacuum grooves exhibits a 4-fold symmetry, i.e. it is symmetric with respect to a rotation of 90° around an axis perpendicularly intersecting the support surface 26 in the central point 32. However, the distribution of the vacuum grooves 30 may also exhibit any other kind of symmetry or no symmetry at all.

The vacuum grooves 31 provided in the connection surface 24 may extend at least sectionally below the vacuum grooves 30.

Some of the vacuum grooves 31 may have essentially the same length and/or the same shape as the respective vacuum groove 30 they are connected to, except for the bigger width.

In particular, pairs of vacuum grooves 30, 31 comprising one of the vacuum grooves 30 in the support surface and one of the vacuum grooves 31 in the connection surface 24 may be formed, wherein the vacuum grooves 30, 31 of each pair are interconnected via one of the through holes 28. The two vacuum grooves 30, 31 in each pair extend one above the other and have the same length and shape except for the width.

The connection surface 24 is allocated to the bearing surface 18 of the handling device 12, more specifically the connection surface 24 is in contact with the bearing surface 18 at least sectionally.

The support surface 26 is allocated to the flexible substrate 16 and is configured to support the flexible substrate 16.

Each of the through holes 28 is allocated to one vacuum opening 20 of the handling device 12. More precisely the through holes 28 are positioned exactly above and aligned with the vacuum openings 20.

A vacuum applied to the vacuum openings 20 is then transferred to the support surface 26, and therefore a force is exerted onto the flexible substrate 16 that acts towards the support surface 26. Thus, the flexible substrate 16 is fixated on the support surface 26.

Exact relative positioning between the handling device 12 and the support plate 14 as well as between the support plate 14 and the flexible substrate is highly relevant for further processing of the flexible substrate 16 in spite of the vacuum grooves 31 compensating at least part of a potential positioning error. Thus, the handling device 12 and/or the support plate 14 may comprise means for facilitating relative positioning of the handling device 12, the support plate 14 and/or the flexible substrate 16.

In the embodiment shown in FIGS. 1 and 2, the handling device 12 comprises windows 34 that enable a backside alignment of the flexible substrate 16 through the translucent support plate 14. Therefore, a particularly accurate positioning of the flexible substrate 16 on the support plate 14 and/or of the support plate 14 on the handling device 12 is achievable.

Accordingly, the support plate 14 is translucent at least in regions that are allocated to the windows 34. The remaining areas of the support plate 14 may be translucent or opaque.

Moreover, the support plate 14 and the flexible substrate 16 may comprise notches 36, 38 that correspond to each other, i.e. a correct relative alignment between the support plate 14 and the flexible substrate is achieved when the notches 36, 38 exactly lie on top of each other.

Alternatively or additionally, the support plate 14 may comprise an alignment mark 40 corresponding to a notch 38 of the flexible substrate 16.

Summarizing, the support plate 14 is configured as an attachment to the handling device 12, which is adapted to the particular substrate 16 to be fixated. For handling different kinds and sizes of substrates 16, the support plate 14 may be simply replaced with another one adapted to the different substrate and/or substrate size. Thus, it is possible to use the same handling device 12 for a large variety of different substrates and substrate sizes.

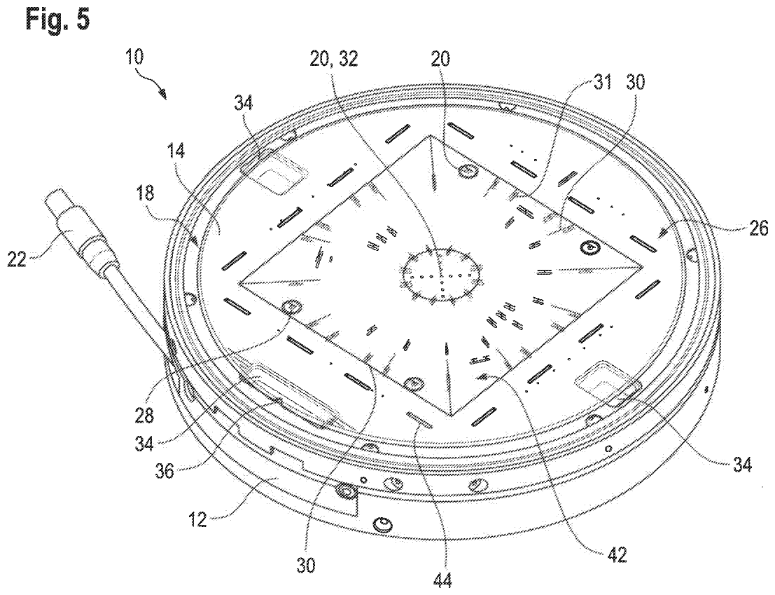

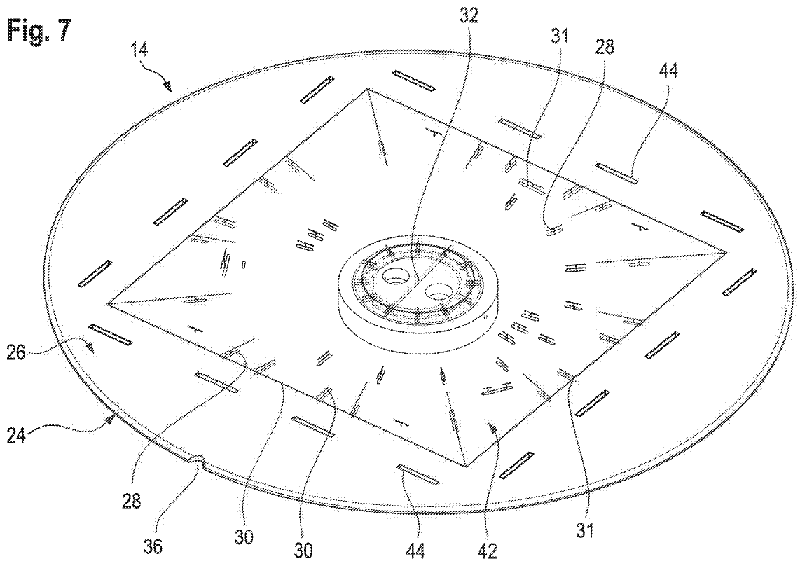

In FIGS. 5 to 8, a second embodiment of the fixation system 10 is shown, which essentially differs from the one described above in the configuration of the support plate 14 and of the flexible substrate 16.

In the following, only the differences compared to the first embodiment described above will be explained, wherein like numerals label the same components or components of like functionality.

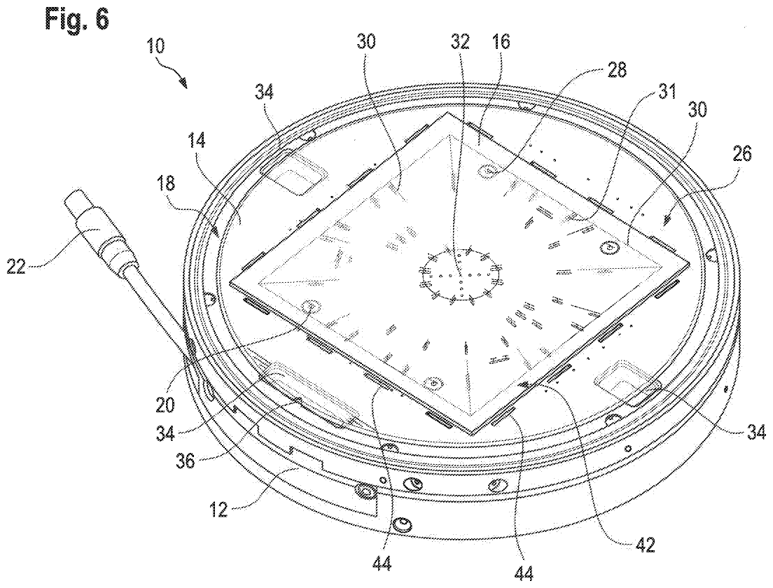

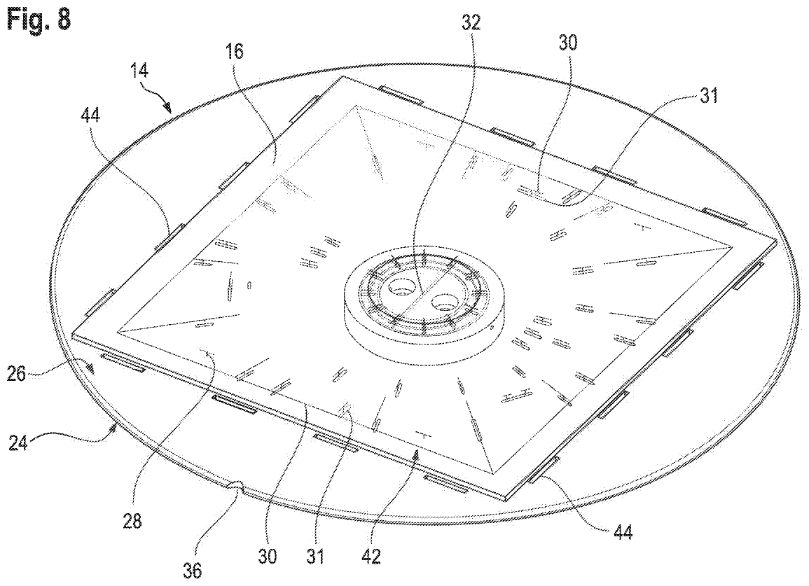

In the example shown. In FIGS. 6 and 8, the flexible substrate 16 has a substantially rectangular form. The explanations given below, however, apply to an arbitrary shape of the flexible substrate 16.

The area of the flexible substrate 16 is smaller than the area of the bearing surface 18 and also smaller than the area of the support surface 26.

In order to efficiently hold the flexible substrate 16, the support plate 14 comprises a receiving section 42 on its support surface 26 that is configured to receive and fixate the flexible substrate 16. The receiving section 42 is the same size as the flexible substrate 16.

In particular, the through holes 28 as well as the vacuum grooves 30 are all located within the receiving section 42, such that optimal suction of the flexible substrate is provided and no energy is wasted for applying a vacuum to through holes 28 that are not in fluidic communication with the flexible substrate 16.

Moreover, one of the vacuum grooves 30 extends along a contour similar to a contour of the flexible substrate 16. The term “similar” is to be understood in the mathematical sense, such that one of the vacuum grooves 30 extends along a contour that is equal to the contour of the flexible substrate 16 or scaled in size.

This vacuum groove 30 is therefore configured to hold the flexible substrate 16 in its edge region.

In order to facilitate positioning of the flexible substrate 16 in the receiving section 42, the receiving section 42 is defined by engravings 44. In this embodiment the engravings 44 form parts of the alignment structure.

In all of the variants describes above, the support plate 14 may consist of a suitable type of glass or metal. Preferably, the support plate is at least partially produced from a photostructurable glass.

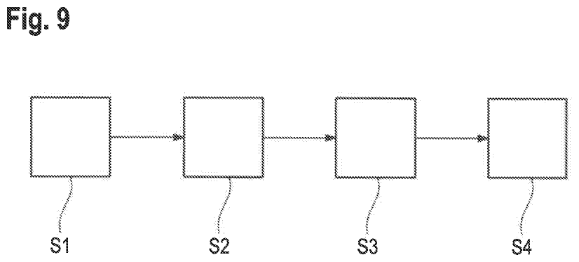

A method for producing the support plate 14 from a photostructurable glass is described in the following with reference to FIG. 9.

First, a base body made of a photostructurable glass is provided (step S1). The base body may already have the underlying shape of the support plate 14 to be produced, but without fine details such as the vacuum grooves 30, the vacuum grooves 31 and/or the through holes 28.

Next, a photo mask is arranged on the base body (step S2), wherein the photo mask essentially is a negative of the structures to be produced, i.e. the vacuum grooves 30, the vacuum grooves 31 and/or the through holes 28.

Then, the base body is exposed, in particular exposed with UV light wherein the light induces a chemical reaction in the exposed areas (step S3).

If necessary, the base body may now be tempered at a suitable temperature.

Finally, the base body is etched (step S4), so that the material of the base body is removed in exactly the areas that had been exposed, i.e. that had not been covered by the mask. Thus, the vacuum grooves 30, the vacuum grooves 31 and/or the through holes 28 are created and the desired support plate 14 is obtained.

Vacuum grooves 30, 31 produced in this way are characterized by a high achievable aspect ratio of the vacuum grooves 30, 31 (depth of a structure divided by its width). In particular, aspect ratios of more than 10 are achievable.

1. A fixation system for fixing a flexible substrate, comprising a handling device and a support plate being separate from the handling device, wherein the handling device comprises a bearing surface with vacuum openings, wherein the support plate comprises a support surface for supporting the substrate and a connection surface in contact with the bearing surface of the handling device, wherein the support plate comprises through holes extending from the support surface to the connection surface, and wherein at least one of the through holes is fluidically connected to one of the vacuum openings of the handling device.

2. The fixation system according to claim 1, wherein the support plate comprises vacuum grooves in the support surface that are each fluidically connected to at least one through hole.

3. The fixation system according to claim 2, wherein the vacuum grooves extend at least one of radially outwards from a center point of the support plate, in an azimuthal direction of the support plate or along a contour similar to a contour of the substrate.

4. The fixation system according claim 1, wherein the support plate comprises an alignment structure.

5. The fixation system according to claim 4, wherein the alignment structure comprising at least one of an engraving, a notch or an alignment mark.

6. The fixation system according to claim 1, wherein at least one of the handling device or the support plate are translucent at least sectionally.

7. The fixation system according to claim 1, wherein the support plate, at least partly, consists of a photostructurable glass.

8. The fixation system according to claim 1, wherein the support plate comprises vacuum grooves in the connection surface that are each fluidically connected to at least one through hole.

9. The fixation system according to claim 8, wherein at least one of a width or a length of the vacuum grooves provided in the connection surface is bigger than at least one of a width or a length of vacuum grooves provided in the support surface.

10. The fixation system according to claim 1, wherein at least two of the through holes are fluidically separate on at least one of the connection surface or the support surface.

11. The fixation system according to claim 1, wherein the support plate comprises at least ten through holes.

12. The fixation system according to claim 11, wherein the support plate comprises at least 20 through holes.

13. The fixation system according to claim 1, wherein the support plate comprises a receiving section on the support surface.

14. The fixation system according to claim 13, wherein the through holes are provided in the receiving section.

15. The fixation system according to claim 1, wherein the handling device is at least one of a chuck or an end effector.

16. A support plate for a fixation system for fixing flexible substrates, comprising a support surface for supporting the substrate and a connection surface for connecting the support plate with a handling device, wherein the support plate comprises through holes extending from the support surface to the connection surface, wherein at least two of the through holes are fluidically separate on the connection surface.

17. The support plate according to claim 16, wherein the support plate comprises at least ten through holes.

18. The support plate according to claim 17, wherein the support plate comprises at least 20 through holes.

19. A method for producing a support plate for a fixation system for fixing a flexible substrate, in particular a support plate for a fixation system according to any one of the preceding claims, comprising the following steps:
providing a base body made of a photostructurable glass;
arranging a photo mask on the base body;
exposing the base body; and
etching the base body creating at least one of vacuum grooves or through holes.

20. The Method according to claim 19, wherein the support plate comprises a support surface for supporting the substrate and a connection surface for connecting the support plate with a handling device, wherein the support plate comprises through holes extending from the support surface to the connection surface, wherein at least two of the through holes are fluidically separate on the connection surface.
